(19) United States
(12) Patent Application Publication
(10) Pub. No.: US 2023/0394903 A1
(43) Pub. Date: Dec. 7, 2023

(54) SHEET MANAGEMENT DEVICE, SHEET MANAGEMENT SYSTEM, AND SHEET MANAGEMENT METHOD

(71) Applicant: Glory Ltd., Himeji-shi (JP)

(72) Inventors: Ken MATSUHASHI, Himeji-shi (JP); Minoru HIGASHIYAMA, Himeji-shi (JP); Toshikazu NAGASAKI, Himeji-shi (JP); Hiromichi OKIZUKA, Himeji-shi (JP); Heisuke OHNO, Himeji-shi (JP)

(73) Assignee: Glory Ltd., Himeji-shi (JP)

(21) Appl. No.: 18/236,410

(22) Filed: Aug. 22, 2023

Related U.S. Application Data
(63) Continuation of application No. PCT/JP22/07844, filed on Feb. 25, 2022.

(30) Foreign Application Priority Data
Mar. 11, 2021 (JP) 2021-038942

(51) Int. Cl. G07D 11/50; G07D 11/34

(52) U.S. Cl. CPC G07D 11/50; G07D 11/34

(57) ABSTRACT

In order to manage a group of sheets to be distinguished from other sheets, a sheet management device is configured to: generate first block data that includes identification information of a plurality of sheets handled by a first sheet handling apparatus and a first eigenvalue calculated based on first input values including the identification information; generate second block data that includes identification information obtained by handling the plurality of sheets by a second sheet handling apparatus and a second eigenvalue calculated based on second input values including the first eigenvalue and the identification information obtained by the second sheet handling apparatus; and manage the second block data in association with the first block data.

### CROSS-REFERENCE TO RELATED APPLICATIONS

The present application is a bypass continuation of, and claims priority to, International application PCT/JP2022/007844, filed Feb. 25, 2022, the entire contents of which is incorporated herein by reference. PCT/JP2022/007844 claims priority to JP 2021-038942, filed Mar. 11, 2021, the entire contents of which is incorporated herein by reference.

### TECHNICAL FIELD

The present disclosure relates to a sheet management device, a sheet management system, and a sheet management method for managing sheets.

### BACKGROUND ART

Conventionally, a sheet handling apparatus capable of handling a large number of sheets has been used. For example, when a cash-in-transit (CIT) company collects banknotes from a plurality of stores, the CIT can use such a banknote handling apparatus to handle all the banknotes collected from each store together in one banknote handling. In this banknote handling, the banknote handling apparatus needs to distinguish banknotes of each store from banknotes of other stores in order to obtain a handling result for each store.

U.S. Pat. No. 5,917,930 discloses a technology using separator cards that allow a banknote handling apparatus to distinguish a plurality of batches of banknotes from each other. When the banknote handling apparatus handles a plurality of batches of banknotes together, the respective batches of banknotes are separated by the separator cards. Each separator card is provided with a magnetic strip. The banknote handling apparatus detects each separator card based on the magnetic stripe. By detecting the separator cards, the banknote handling apparatus can distinguish each batch of banknotes and handle each batch separately.

Japanese Laid-Open Patent Publication No. 2016-103054 discloses a technology using serial numbers of banknotes so that a banknote handling apparatus can distinguish banknotes of a plurality of transactions from each other. In each transaction, serial numbers of all banknotes included in one transaction are associated with a transaction number assigned to each transaction. The banknotes of all the transactions are stored in one bag, and a paper strip on which a two-dimensional barcode is printed is attached to the bag. The two-dimensional barcode includes the transaction numbers of the respective transactions, the serial numbers of all the banknotes, and information indicating correspondence between the transaction numbers and the serial numbers. When handling the banknotes stored in the bag, the banknote handling apparatus reads the two-dimensional barcode from the paper strip attached to the bag. The information obtained from the two-dimensional barcode enables the banknote handling apparatus to specify the transaction number corresponding to the serial number of each banknote. The banknote handling apparatus reads the serial number from each banknote to specify the transaction number corresponding to the serial number, distinguishes the banknotes of respective transactions and handles the banknotes of each transaction separately.

### SUMMARY

In the above conventional technologies, managing a group of sheets, i.e., a batch of banknotes, banknotes of one transaction, etc., takes time and labor. For example, in the technology of PATENT LITERATURE 1, it is necessary to prepare a plurality of separator cards and insert the separator cards so as to separate the batches of banknotes. In the technology of PATENT LITERATURE 2, it is necessary to associate the serial numbers of the banknotes with the transaction numbers, create the two-dimensional barcode indicating the associations, print the barcode on the paper strip, and attach the paper strip to the bag having the banknotes stored therein. When taking out the banknotes from the bag to handle them, it is necessary to read the two-dimensional barcode from the paper strip attached to the bag.

The present disclosure is made in view of the above problems, and one object of the present disclosure is to provide a sheet management device, a sheet management system, and a sheet management method capable of easily managing a group of sheets.

A sheet management device according to one aspect of the present disclosure is configured to: generate first block data that includes identification information of a plurality of sheets handled by a first sheet handling apparatus and a first eigenvalue calculated based on first input values including the identification information; generate second block data that includes identification information obtained by handling the plurality of sheets by a second sheet handling apparatus and a second eigenvalue calculated based on second input values including information on the first eigenvalue and the identification information obtained by the second sheet handling apparatus; and manage the second block data in association with the first block data. The objects, features, advantages and technical and industrial significance of this disclosure will be better understood by the following description and the accompanying drawings of the disclosure.

### BRIEF DESCRIPTION OF THE DRAWINGS

FIG. 1 shows an exemplary configuration of a sheet management system according to an embodiment of the present disclosure.

FIG. 2 illustrates an outline of processing performed by a management device.

FIG. 3 illustrates block data generated by the management device.

FIG. 4 illustrates an example of block data including no sheet-group eigenvalue and no transaction information.

FIG. 5 shows a specific example of block data obtained by handling sheets.

FIGS. 6A to 6C illustrate examples in which a handling eigenvalue and a sheet-group eigenvalue change between block data.

FIG. 7 is a schematic diagram showing an example of banknote handling performed in the sheet management system.

FIG. 8 is a flowchart showing a flow of processing performed on banknotes.

FIG. 9 shows an example of block data generated during the processing shown in FIG. 8.

FIGS. 10A and 10B show examples of a screen displayed during the processing shown in FIG. 8.

FIG. 11 is a schematic diagram illustrating processing performed when banknotes are collected from a plurality of stores.

FIG. 12 shows an example of a screen on which block data are displayed.

### DESCRIPTION OF EMBODIMENTS

Hereinafter, a sheet management device, a sheet management system, and a sheet management method according to the present disclosure will be described with reference to the accompanying drawings. As for sheets described in the present embodiment, the kinds thereof are not particularly limited as long as each sheet has identification information with which the sheet can be uniquely specified. Examples of the sheets include banknotes having serial numbers, and checks having check numbers. The content of identification information is not particularly limited as long as it can be used to uniquely specify each sheet. For example, identification information may be an identification number such as the serial number or the check number. The identification information may be a combination of an identification number and other information. Specifically, identification information may be a combination of an identification number and information indicating the kind of a sheet, so that, even if different kinds of sheets have the same identification number, each sheet can be uniquely specified by the identification information.

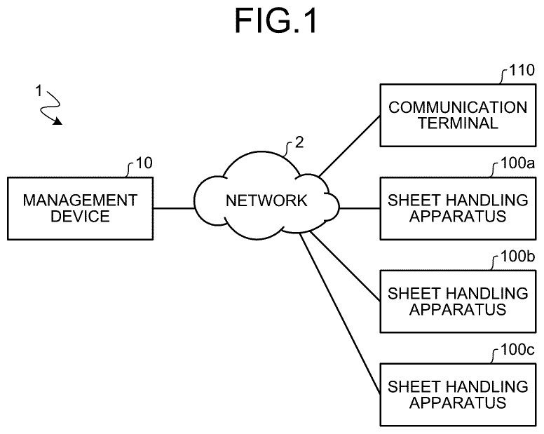

FIG. 1 shows an exemplary configuration of a sheet management system 1 according to the present embodiment. The sheet management system 1 includes a sheet management device 10 (“management device” in FIG. 1), and a plurality of sheet handling apparatuses 100 (100a, 100b, 100c). The sheet management system 1 may include a communication terminal 110 than can be communicably connected to the sheet management device 10. FIG. 1 is an example, and the number of sheet handling apparatuses 100 and the number of communication terminals 110 are not particularly limited. Hereinafter, the sheet management device 10 is simply referred to as the management device 10.

Each sheet handling apparatus 100 includes an operation unit, a display unit, a control unit, a memory, and a sheet handling unit. The configuration of the sheet handling apparatus 100 is not particularly limited as long as the apparatus can obtain identification information from each of a plurality of sheets. For example, an operation terminal including the operation unit, the display unit, and the memory may be connected to another device including the sheet handling unit, and the sheet handling apparatus 100 may be implemented by the device and the operation terminal.

The sheet handling apparatus 100 can handle a plurality of sheets together by one sheet handling, based on an operation received via the operation unit. The sheet handling apparatus 100 can obtain identification information of each sheet when handling the sheet.

For example, the sheet handling apparatus 100 receives a plurality of sheets and feeds the sheets one by one into inside the apparatus, reads identification information of each sheet, and recognizes the kind of each sheet. The sheet handling apparatus 100 can recognize the kind of each sheet, based on at least one of characteristics of the sheet, such as optical characteristics, magnetic characteristics, size, and thickness. The sheet handling apparatus 100 handles the sheets based on recognition results and obtains a handling result. The handling result may be stored in the memory, displayed on the display unit, or transmitted to an external device. For example, the sheet handling apparatuses 100 may be a banknote handling apparatus that reads the serial number of each banknote while recognizing and counting the banknotes, or a check handling apparatus that reads the check number of each check while recognizing and counting the checks. Since the functions, configurations, and operations of these apparatuses have conventionally been known, detailed description thereof is omitted.

The communication terminal 110 is a computer device including an operation unit, a display unit, a control unit, and a memory. The communication terminal 110 is used for operating the management device 10 via a network 2, for example. The communication terminal 110 is used for confirming information managed in the management device 10, for example.

The management device 10 is a computer device including an operation unit, a display unit, a control unit, and a memory. The configuration of the management device 10 is not particularly limited as long as the device can manage information on the sheets handled by the sheet handling apparatuses 100. For example, the management device 10 may not necessarily include the operation unit and the display unit, and may be operated by using the communication terminal 110. For example, the management device 10 may be implemented by combining a plurality of devices.

The management device 10 can obtain information on the sheets handled by each sheet handling apparatus 100, via the network 2. The information on the sheets may not necessarily be obtained by using the network 2, and may be obtained by using another communication technology, or via a storage medium. The management device 10 manages the sheets, based on the obtained information on the sheets.

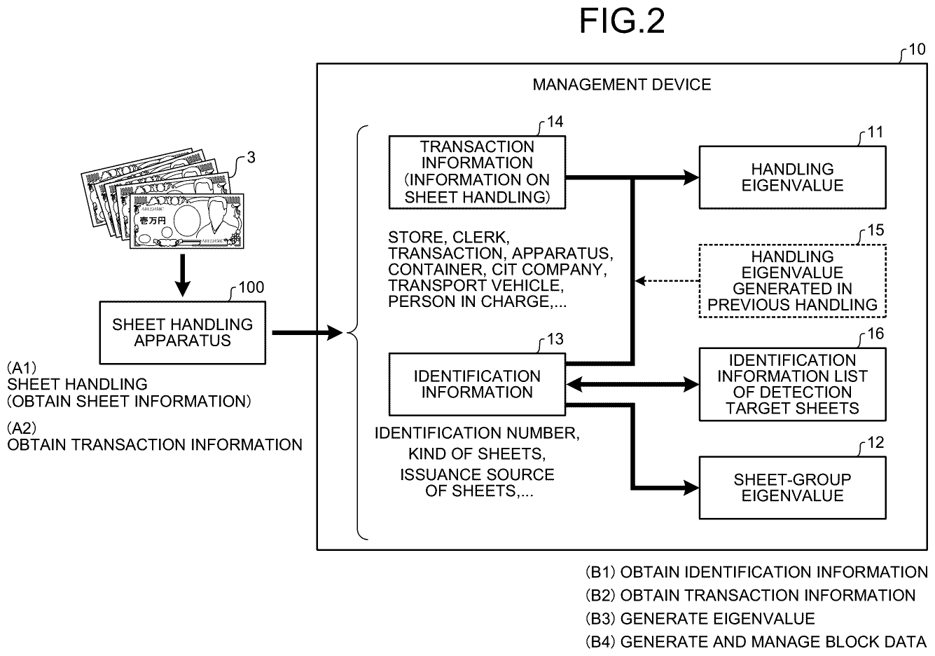

FIG. 2 illustrates an outline of processing performed by the management device 10. The sheet handling apparatus 100 handles a group of sheets 3 to obtain information on each sheet (A1). The information obtained by the sheet handling apparatus 100 includes identification information of each sheet. The sheet handling apparatus 100 can receive an input of transaction information (A2).

The group of sheets 3 is a plurality of sheets that the management device 10 manages together as one batch. The transaction information is information that the management device 10 manages together with information on the sheets 3 when managing the sheets 3.

For example, when a CIT company collects banknotes from a plurality of stores, banknotes of each store are treated as a group of sheets 3. In this case, identification information of each container that stores therein the banknotes of each store is used as the transaction information, for example. Hereinafter, “a group of sheets 3” consisting of a plurality of sheets may be simply referred to as “sheets 3”.

The management device 10 obtains identification information 13 of the sheets 3 handled by the sheet handling apparatus 100 (B1). For example, when the sheets 3 consists of 100 sheets, the management device 10 obtains 100 pieces of identification information 13.

Each piece of identification information 13 includes an identification number of each sheet. The content of the identification information 13 that the management device 10 obtains from the sheet handling apparatus 100 can be changed through setting. The identification information 13 may include information indicating the kind of the sheet, in addition to the identification number. For example, when the sheet is a banknote, the identification information 13 may be a combination of the serial number of the banknote, and at least one of information indicating the denomination of the banknote (e.g., 1 dollar note, 5 dollar note, etc.), and information indicating the kind of currency of the banknote (e.g., US note, Canada note, etc.). When the sheet is a check, the identification information 13 may be a combination of the check number and information indicating the issuance source of the check.

The management device 10 can detect a sheet that satisfies a predetermined condition by using an identification information list 16. In the identification information list 16, identification information of sheets designated as detection targets is registered in advance. The identification information list 16 may be stored in the memory of the management device 10, or may be stored in another device that allows the management device 10 to access the identification information list 16.

For example, identification information of counterfeit sheets and identification information of stolen sheets are registered in the identification information list 16. The management device 10 can determine whether or not identification information registered in the identification information list 16 is included in the identification information 13 obtained from the sheet handling apparatus 100. If identification information 13 of a sheet handled in the sheet handling apparatus 100 matches identification information in the identification information list 16, the management device 10 can notify this to the user of the sheet management system 1. The notification is performed by displaying information indicating the determination result on at least one of the display unit of the management device 10, the display unit of the communication terminal 110, and the display unit of the sheet handling apparatus 100, for example.

When the management device 10 has detected identification information registered in the identification information list 16 from the identification information 13 of the sheets 3, the management device 10 can use the detection result for post-handling of the sheets 3. For example, when the sheets 3 are to be handled by another sheet handling apparatus 100, the management device 10 can cause this sheet handling apparatus 100 to reject a sheet whose identification information is registered in the identification information list 16, thereby eliminating this sheet from the sheets 3, which will be described later in detail.

The management device 10 can obtain transaction information 14 from the sheet handling apparatus 100 (B2). The transaction information 14 may not necessarily be obtained from the sheet handling apparatus 100, and may be obtained from another device such as the communication terminal 110. The management device 10 can manage the sheets 3 by using only the identification information 13 without using the transaction information 14, which will be described later in detail.

The content of the transaction information 14 is not particularly limited. Information selected by the user of the sheet management system 1 may be included in the transaction information 14. In an example where the CIT company collects the sheets 3 from a store, the CIT company and the store can select information to be used for managing the sheets 3 and include the selected information to the transaction information 14.

For example, when the sheets 3 of the store handled by the sheet handling apparatus 100 are packed in a transport container and carried out from the store, at least one of: information on the store; information on a transaction in which the sheets 3 are handled; and information on the sheet handling apparatus 100, may be selected and included in the transaction information 14. Information on the transport container, information on the CIT company, etc., may be selected and included in the transaction information 14.

The management device 10 can generate a handling eigenvalue 11 and a sheet-group eigenvalue 12 that are to be used for management of the sheets 3 (B3). The handling eigenvalue 11 is generated based on the identification information 13 and the transaction information 14. The sheet-group eigenvalue 12 is generated based on the identification information 13.

The sheet-group eigenvalue 12 is a value that is outputted from a predetermined identification-information function when all the pieces of identification information 13 of the sheets 3 are inputted to the identification-information function. The identification-information function is prepared in advance such that the value of the sheet-group eigenvalue 12 changes with a change in the input value thereto. For example, if the sheets 3 are 100 sheets, 100 pieces of identification information 13 are inputted to the identification-information function, and one sheet-group eigenvalue 12 is outputted from the identification-information function. If even one of the pieces of identification information 13 inputted to the identification-information function changes, the sheet-group eigenvalue 12 outputted from the identification-information function changes.

The handling eigenvalue 11 is a value that is outputted from a predetermined handling-history function when all the pieces of identification information 13 of the sheets 3 and the transaction information 14 are inputted to the handling-history function. The handling-history function is prepared in advance such that the value of the handling eigenvalue 11 changes with a change in the input value thereof. For example, if the sheets 3 are 100 sheets, 100 pieces of identification information 13 and the transaction information 14 are inputted to the handling-history function, and one handling eigenvalue 11 is outputted from the handling-history function. If even one of the pieces of identification information 13 to be inputted to the handling-history function changes, the handling eigenvalue 11 outputted from the handling-history function changes. Likewise, if the transaction information 14 inputted to the handling-history function changes, the handling eigenvalue 11 outputted from the handling-history function changes.

If there is a handling eigenvalue 15 generated for the sheets 3 in the past, this handling eigenvalue 15 is also added to the input values for the handling-history function. That is, the handling eigenvalue 11 is generated based on the identification information 13, the transaction information 14, and the handling eigenvalue 15. If the handling eigenvalue 15 to be inputted to the handling-history function changes, the handling-history function outputs a different handling eigenvalue 11. A method for using the past handling eigenvalue 15 will be described later in detail.

The identification-information function and the handling-history function each preferably output a value of a fixed length even if the input value thereto varies. For example, a hash function may be used as the handling-history function, and a hash value obtained from the hash function may be used as the handling eigenvalue 11. Likewise, a hash function may be used as the identification-information function, and a hash value obtained from the hash function may be used as the sheet-group eigenvalue 12.

The management device 10 can generate and manage block data including a handling eigenvalue 11, a sheet-group eigenvalue 12, identification information 13, and transaction information 14 (B4). The management device 10 can generate block data each time the sheets 3 are handled, and manage all the generated block data in association with each other.

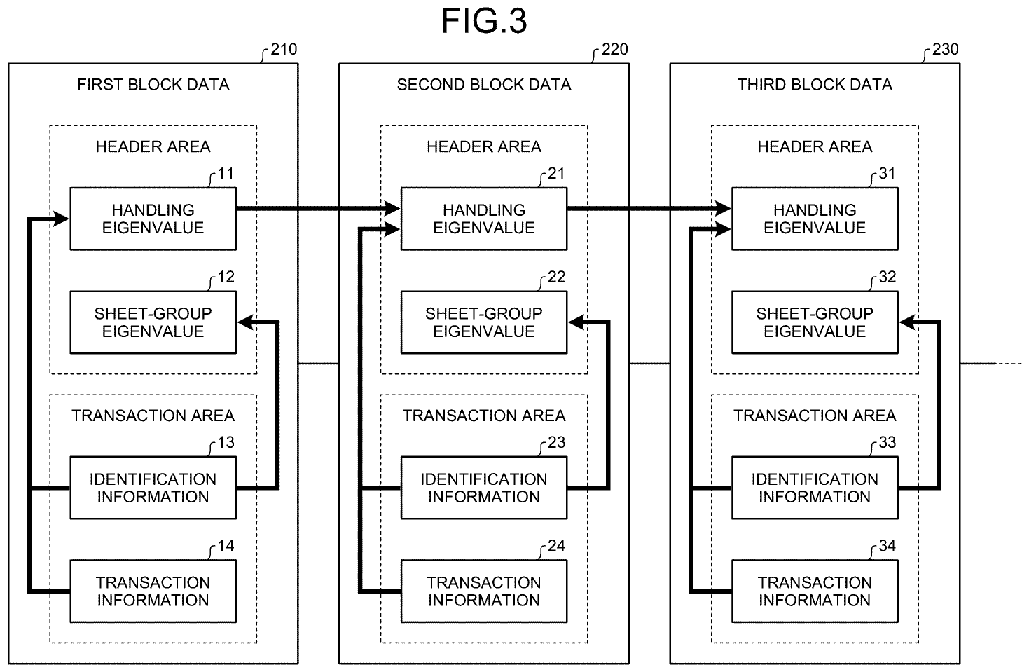

FIG. 3 illustrates block data generated by the management device 10. For example, the management device 10 generates first block data 210 when sheets 3 are handled in the first sheet handling apparatus 100a installed in the store.

As shown in FIG. 3, each block data is separated into a header area at the top of the block data, and a following transaction area. In the first block data 210, identification information 13 and transaction information 14 are stored in the transaction area. If the sheets 3 are 100 sheets, 100 pieces of identification information 13 are stored in the transaction area. If the transaction information 14 includes plural pieces of information, all these pieces of information are stored in the transaction area.

As described with reference to FIG. 2, the management device 10 inputs the identification information 13 into the identification-information function to generate a sheet-group eigenvalue 12, and inputs the identification information 13 and the transaction information 14 into the handling-history function to generate a handling eigenvalue 11. The management device 10 stores the generated handling eigenvalue 11 and sheet-group eigenvalue 12 in the header area of the first block data 210.

Thus, as shown in FIG. 3, the generated first block data 210 includes the handling eigenvalue 11, the sheet-group eigenvalue 12, the identification information 13, and the transaction information 14. The handling eigenvalue 11 generated from the identification information 13 and the transaction information 14, and the sheet-group eigenvalue 12 generated from the identification information 13, are stored in the header area, as shown by arrows in FIG. 3.

When the sheets 3 are subjected to the second sheet handling, second block data 220 is generated. For example, when the sheets 3 handled in the first sheet handling apparatus 100a of the store are transported from the store to another place and handled in the second sheet handling apparatus 100b at that place, the management device 10 obtains the identification information and the transaction information of the sheets 3 from the second sheet handling apparatus 100b as described with reference to FIG. 2.

The management device 10 searches for block data generated in the past, with respect to the sheets 3 handled in the second sheet handling apparatus 100b. For example, based on one piece of identification information included in identification information 23 obtained from the second sheet handling apparatus 100b, the management device 10 searches for past block data including the same identification information. For another example, based on one piece of information included in transaction information 24 obtained from the second sheet handling apparatus 100b, the management device 10 searches for past block data including the same information. Thus, the management device 10 can know the presence of the first block data 210.

When there is the first block data 210, the management device 10 generates the second block data 220. If there is not a first block data, the management device 10 generates the first block data. If there is the second block data in addition to the first block data, the management device 10 generates the third block data.

As shown in FIG. 3, the management device 10 stores, in the transaction area of the second block data 220, the identification information 23 and the transaction information 24 of the sheets 3 obtained from the second sheet handling apparatus 100b. The management device 10 generates a sheet-group eigenvalue 22 from the identification information 23, and stores it in the header area of the second block data 220, as shown by an arrow in FIG. 3.

The sheet-group eigenvalue 12 in the first block data 210 and the sheet-group eigenvalue 22 in the second block data 220 are generated from the identification information of the same sheets 3. Therefore, the sheet-group eigenvalue 22 and the sheet-group eigenvalue 12 have the same value. The management device 10 can compare these two sheet-group eigenvalues 12 and 22 with each other to determine whether or not the sheets 3 handled by the second sheet handling apparatus 100b match the sheets 3 handled by the first sheet handling apparatus 100a.

If the two sheet-group eigenvalues 12 and 22 do not match, the management device 10 compares the identification information 13 in the first block data 210 with the identification information 23 in the second block data 220, and detects different identification information between them. The management device 10 can notify the detected identification information to the user. In addition, the management device 10 can notify that the sheets handled in the second sheet handling apparatus 100b do not match the sheets 3 handled in the first sheet handling apparatus 100a. The notification is performed by displaying related information on at least one of the display unit of the management device 10, the display unit of the communication terminal 110, and the display unit of the second sheet handling apparatus 100b. The notification enables investigation for the cause of the mismatch between the sheets 3 handled in the first sheet handling apparatus 100a and the sheets handled in the second sheet handling apparatus 100b.

The management device 10 generates a handling eigenvalue 21 in the second block data 220, from the identification information 23 and the transaction information 24 in the second block data 220, and the handling eigenvalue 11 in the first block data 210, as shown by arrows in FIG. 3. The management device 10 stores the handling eigenvalue 21 in the header area of the second block data 220. Thus, as shown in FIG. 3, the generated second block data 220 includes the handling eigenvalue 21, the sheet-group eigenvalue 22, the identification information 23, and the transaction information 24. The management device 10 manages the second block data 220 in association with the first block data 210. That is, the second block data 220 is managed in association with the first block data 210 including the handling eigenvalue 11 that has been used as one of the input values for generating the second block data 220.

When performing the third handling of the sheets 3, third block data 230 is generated. The third block data 230 is generated in the same method as that for the second block data 220. The handling eigenvalue 21 in the second block data 220 is used for generating a handling eigenvalue 31 in the third block data 230, as shown by an arrow in FIG. 3. The third block data 230 including the handling eigenvalue 31, a sheet-group eigenvalue 32, identification information 33, and transaction information 34 is managed in association with the second block data 220.

The management device 10 generate block data each time the sheets 3 are handled. Newly generated block data is managed in association with block data generated in the immediately previous handling. Thus, the management device 10 manages all the block data generated for the same sheets 3 in association with each other.

FIG. 3 shows an example of the block data and the management device 10 may not necessarily use the sheet-group eigenvalue. Specifically, the management device 10 may not necessarily generate a sheet-group eigenvalue. The management device 10 may generate a sheet-group eigenvalue but may not necessarily include it in the block data. The management device 10 may not necessarily use the transaction information. Specifically, the management device 10 may not necessarily include the transaction information in the block data. The management device 10 may not necessarily include the transaction information in the input values for generating a handling eigenvalue.

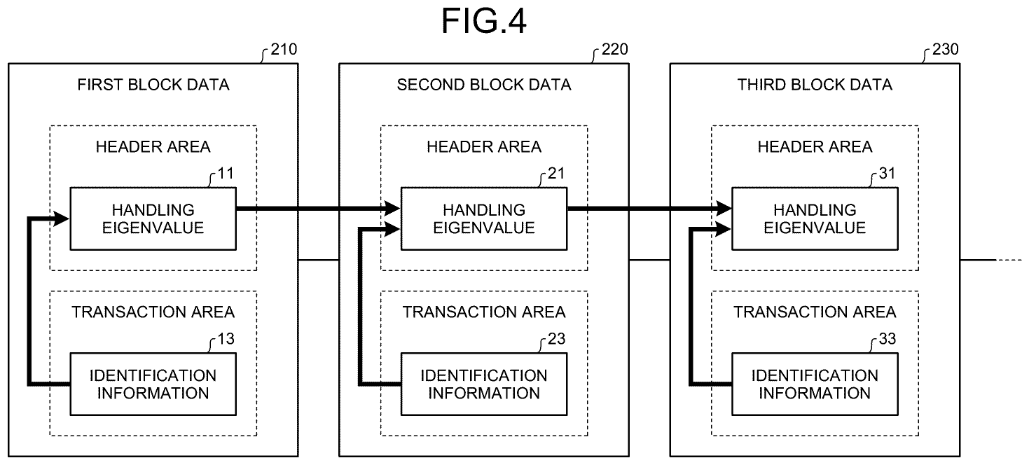

FIG. 4 shows an example of block data in which neither sheet-group eigenvalue nor transaction information is included. In the case of using no transaction information, the handling eigenvalue 11 in the first block data 210 is generated from the identification information 13 as shown by an arrow in FIG. 4. The handling eigenvalue 21 in the second block data 220 is generated from the identification information 23 of the second block data 220 and the handling eigenvalue 11 of the first block data 210. The handling eigenvalue 31 in the third block data 230 is generated from the identification information 33 of the third block data 230 and the handling eigenvalue 21 of the second block data 220. In this case, for example, the process of confirming whether or not the information on the sheets included in the first block data 210 matches the information on the sheets included in the second block data 220, can be performed by comparing the identification information 13 in the first block data 210 with the identification information 23 in the second block data 220. Specifically, the management device 10 performs a process of checking the plural pieces of sheet identification information 13 in the transaction area of the first block data 210 with the plural pieces of sheet identification information 23 in the transaction area of the second block data 220. Thus, the management device 10 can determine whether or not the sheets 3 handled in the second sheet handling apparatus 100b match the sheets 3 handled in the first sheet handling apparatus 100a.

The management device 10 generates block data each time the sheets 3 are handled. In the second handling and subsequent handlings, n-th (n: integer not less than 2) block data is generated. The n-th block data includes: identification information of each sheet obtained in the n-th handling; and a handling eigenvalue generated from all pieces of identification information and a handling eigenvalue generated in the (n−1)-th handling. The n-th block data is managed in association with the (n−1)-th block data. Such data is sometimes referred to as a block chain.

The block data generation timing is not limited to the timing when the sheets 3 are handled in different sheet handling apparatuses 100. For example, block data may be generated when sheets are handled again in the same sheet handling apparatus 100. For another example, block data may be generated when the content of handling performed in the sheet handling apparatus 100 is approved by using another apparatus. Specifically, after block data is generated by handling sheets in the sheet handling apparatus 100, another block data may be generated in a process of approving the sheet recognition result, the count result, the block data, etc.

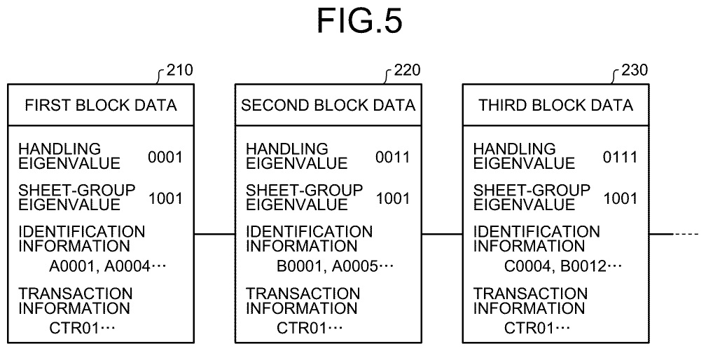

FIG. 5 shows a specific example of block data obtained by handling sheets 3. As shown in FIG. 5, each block data includes identification information, such as “A0001”, read from each of the handled sheets 3. Arrangement of the identification information registered in each block data may change depending on the order in which the sheets were handled, but the same identification information is included in each block data. Therefore, sheet-group eigenvalues included in the respective block data have the same value. Meanwhile, since a handling eigenvalue in the immediately previous block data is included in input values for generating a handling eigenvalue, even if each block data includes the same sheet identification information and the same transaction information, the respective block data have different handling eigenvalues.

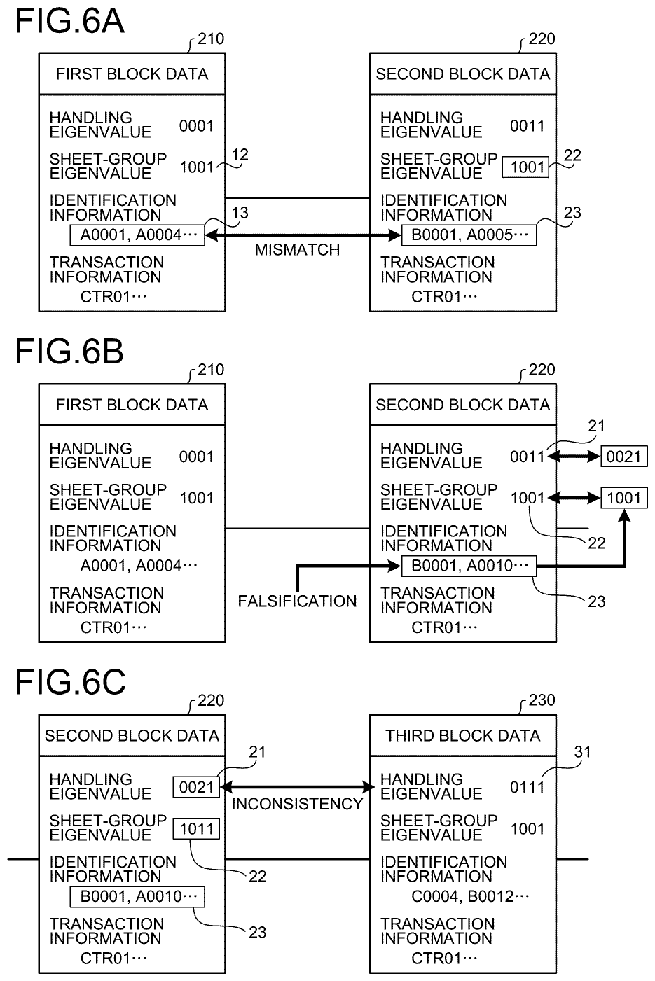

FIGS. 6A to 6C illustrate examples in which the handling eigenvalue and the sheet-group eigenvalue change between block data. As shown in FIG. 6A, if the identification information 13 in the first block data 210 does not match the identification information 23 in the second block data 220, the sheet-group eigenvalue 22 in the second block data 220 is different from the sheet-group eigenvalue 12 in the first block data 210. In the example shown in FIG. 6A, the sheet-group eigenvalue 22 in the second block data 220 is “1011” while the sheet-group eigenvalue 12 in the first block data 210 is “1001”.

Thus, based on that the sheet-group eigenvalues 12 and 22 do not match between the first block data 210 and the second block data 220, the management device 10 recognizes that the identification information 23 in the second block data 220 is different from the identification information 13 in the first block data 210.

For example, after the first block data 210 is generated, if one sheet is taken out from the sheets 3 and thereby the number of the sheets 3 is reduced, the sheet-group eigenvalue 22 in the second block data 220 becomes different from the sheet-group eigenvalue 12 in the first block data 210. The management device 10 can detect this difference and notify abnormality on the handled sheets 3 to the user. The notification is performed by displaying related information on at least one of the display unit of the management device 10, the display unit of the sheet handling apparatus 100 in a bank, and the display unit of the communication terminal 110.

The management device 10 can confirm consistency between the respective block data. A process of confirming consistency may be performed based on an operation of an operator, or may be automatically performed at a predetermined timing. For example, the process may be automatically performed once a day at a predetermined time. For another example, the process may be automatically performed each time new block data is generated. In the process of confirming the consistency, the management device 10 regenerates a handling eigenvalue and a sheet-group eigenvalue in each block data, and compares them with those that have been generated and already registered in the block data.

As shown in FIG. 6B, if the identification information 23 is falsified after generation of the second block data 220, inconsistency occurs between the handling eigenvalue 21 and the sheet-group eigenvalue 22 already registered in the second block data 220, and a handling eigenvalue and a sheet-group eigenvalue that are regenerated with the falsified identification information 23 being an input value.

For example, as shown in FIG. 6B, the handling eigenvalue “0021” and the sheet-group eigenvalue “1011” that are regenerated with the falsified identification information 23 being an input value, do not match the handling eigenvalue 21 “0011” and the sheet-group eigenvalue 22 “1001” in the second block data 220, respectively. Based on this inconsistency, the management device 10 can detect abnormality in the second block data 220 and notify the abnormality to the user. The notification is performed by displaying related information on at least one of the display unit of the management device 10, the display unit of the sheet handling apparatus 100 in the bank, and the display unit of the communication terminal 110. The detection of abnormality on the block data may not necessarily be performed based on both the handling eigenvalue and the sheet-group eigenvalue, and may be performed based on one of them.

If block data is falsified, inconsistency also occurs between this block data and next block data generated after this block data. For example, the handling eigenvalue registered in the third block data 230 has been generated by using, as one of the input values, the handling eigenvalue “0011” in the second block data 220 before falsification. If the second block data 220 is falsified and thereby the regenerated handling eigenvalue becomes “0021”, the handling eigenvalue in the third block data 230 to be regenerated by using the handling eigenvalue “0021” as one input value is also changed. Therefore, when regenerating the handling eigenvalue in the third block data 230 by the management device 10, the regenerated handling eigenvalue becomes different from the handling eigenvalue already registered in the third block data 230. The management device 10 can detect abnormality in the second block data 220 from this inconsistency between the regenerated block data and the existing block data.

As shown in FIG. 6C, even if the handling eigenvalue 21 and the sheet-group eigenvalue 22 can be falsified in addition to the falsified identification information 23 so that inconsistency does not occur in the second block data 220, inconsistency still remains between the second block data 220 and the third block data 230. Therefore, the management device 10 can detect abnormality in the second block data 220, based on the inconsistency between the second block data 220 and the third block data 230.

A handling eigenvalue in n-th block data (n: integer not less than 2) is generated with a handling eigenvalue in (n−1)-th block data being used as one of input values. If the handling eigenvalue changes in certain block data, inconsistency occurs between all adjacent block data generated after the certain block data. In order to avoid this inconsistency, it is necessary to falsify related information in all the block data and therefore, it is difficult to make falsification undetectable. As a result, the management device 10 can reliably detect falsification of block data by periodically confirming consistency between block data.

In FIGS. 6A to 6C, identification information has been described as an example. Also, if transaction information is falsified, a handling eigenvalue regenerated with the falsified transaction information being one input value becomes different from the handling eigenvalue already registered in block data. In addition, consistency cannot be maintained between this block data and next block data generated after this block data. Therefore, the management device 10 can detect that the block data has been falsified.

If some of the sheets 3 are lost or replaced with different sheets while the sheets 3 are being handled a plurality of times, the management device 10 can detect this fact as described above. Also, if block data is falsified, the management device 10 can detect this fact. The management device 10 detects abnormality in data and notifies the detection result to the user, whereby the user can investigate the cause of the abnormality. Based on consistency between adjacent block data, the user can specify block data having the abnormality from among a plurality of block data, and perform investigation related to the specified block data.

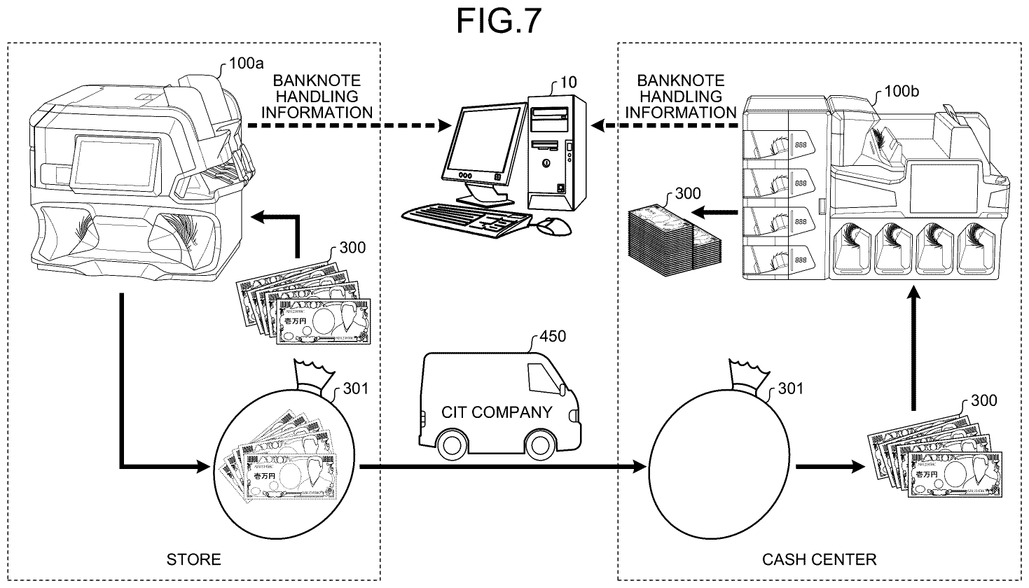

Next, a specific example of processing performed in the sheet management system 1 will be described with banknotes as an example. FIG. 7 is a schematic diagram showing an example of banknote handling performed by using the sheet management system 1. Hereinafter, a description will be given of an exemplary case where banknotes (a group of sheets) 300 are proceeds from sales of a store. In the store, these banknotes are handled by the banknote handling apparatus (sheet handling apparatus) 100a and packed in a bag (container) 301. These banknotes are transported to a cash center by a CIT company 450, and handled by another banknote handling apparatus (sheet handling apparatus) 100b in the cash center.

The management device 10 obtains banknote information from the banknote handling apparatus 100a in the store and the banknote handling apparatus 100b in the cash center, generates block data as described above, and manages the generated block data in association with each other.

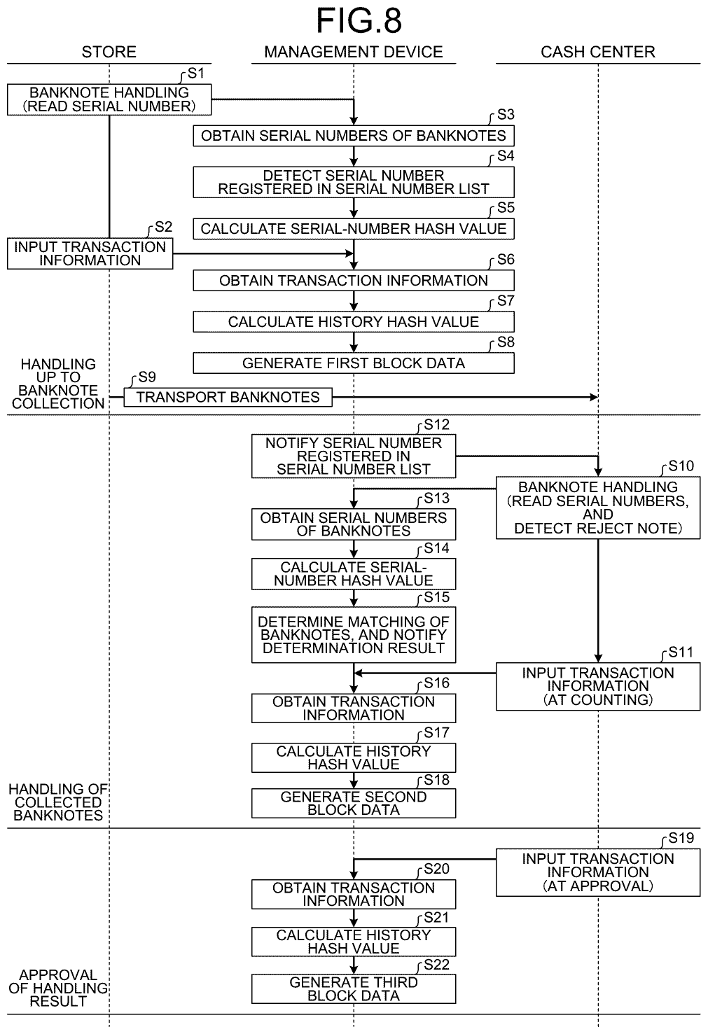

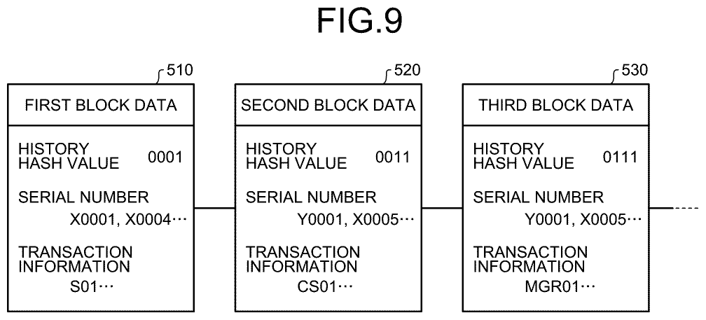

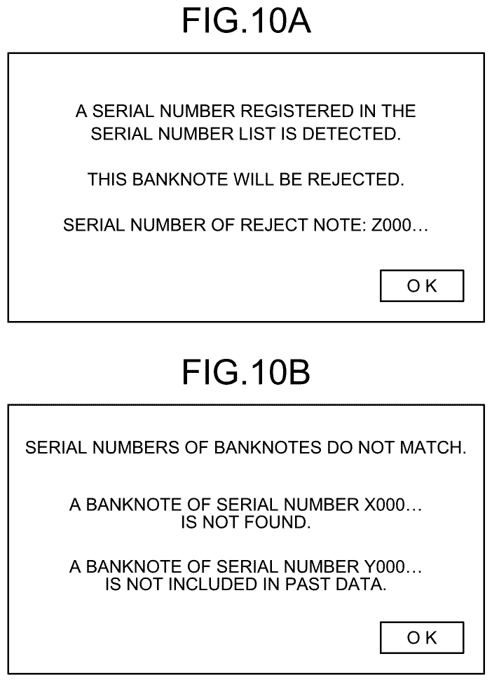

FIG. 8 is a flowchart showing a flow of processing performed on banknotes. FIG. 9 shows an example of block data generated during the processing shown in FIG. 8. FIG. 10 shows an example of a screen displayed during the processing shown in FIG. 8.

A clerk of the store handles banknotes 300, which are the proceeds from sales of the store, by using the banknote handling apparatus 100a (step S1 shown in FIG. 8). In this banknote handling, the banknote handling apparatus 100a reads the serial number of each banknote. The banknote handling apparatus 100a may recognize the denomination of each banknote, count the number of banknotes for each denomination, calculate the amount of banknotes, and display the amount on the display unit.

The clerk may input transaction information into the banknote handling apparatus 100a (step S2). For example, a barcode including container information capable of specifying each bag is attached to the bag 301 used for transporting the banknotes 300. The clerk reads the barcode of the bag 301 with a barcode reader connected to the banknote handling apparatus 100a to input the container information into the banknote handling apparatus 100a. The management device 10 can use the inputted container information as the transaction information.

The clerk may not necessarily input the transaction information. The banknote handling apparatus 100a in the store may use transaction information prepared in advance. For example, if the banknote handling apparatus 100a gives a transaction number to each banknote handling in order to specify the banknote handling, this transaction number may be used as the transaction information. For another example, apparatus information capable of specifying the banknote handling apparatus 100a may be used as the transaction information. If there is store information for specifying each store, the store information inputted to the banknote handling apparatus 100a in advance may be used as the transaction information. In the banknote handling, the banknote handling apparatus 100a transmits at least one of the transaction number, the apparatus information, and the store information to the management device 10 as the transaction information, whereby the management device 10 can use the received transaction information for generating block data.

The management device 10 obtains the serial numbers of the banknotes 300 read by the banknote handling apparatus 100a (step S3). The management device 10 refers to a serial number list prepared in advance, and detects a serial number registered in the serial number list from among the serial numbers obtained from the banknote handling apparatus 100a (step S4). This serial number list corresponds to the identification information list 16 described with reference to FIG. 2. If the serial number registered in the serial number list has been detected from the banknotes 300, the management device 10 stores this serial number in the memory. The stored serial number will be used for the banknote handling in the cash center.

If the serial number registered in the serial number list has been detected from the banknotes 300, a banknote having this serial number is excluded from handling targets in the cash center, as a reject note. Therefore, processes in steps S5 to S8 are performed with this serial number being excluded. That is, first block data 510 is generated by using the serial numbers other than the serial number registered in the serial number list.

If the detected serial number is the serial number of a counterfeit note or a stolen note, the management device 10 can perform a notification process of transmitting the detection of this banknote to predetermined contact information. For example, contact information of a person at the store, the cash center, a bank, etc., who is in charge of dealing with a counterfeit note and a stolen note, may be registered in the management device 10 in advance. In an example where an email address of the person in charge at the bank is registered in the management device 10 in advance, when the serial number of a counterfeit note or a stolen note is detected, the management device 10 transmits, to the person in charge, an email including information such as the detected serial number, a store where the serial number was detected, etc. Upon receiving the email, the person in charge can deal with the counterfeit note or the stolen note, based on a predetermined procedure. For example, the person in charge reports it to the police or the like.

The management device 10 inputs the serial numbers of the banknotes 300 obtained from the banknote handling apparatus 100a into a hash function prepared in advance to calculate a serial-number hash value (step S5). That is, the serial-number hash value is calculated based on the information indicating the serial numbers of the banknotes 300. The hash function and the serial-number hash value respectively correspond to the identification-information function and the sheet-group eigenvalue described with reference to FIG. 1 to FIG. 6. The management device 10 stores the serial-number hash value in association with the first block data 510, and uses it for banknote handling to be performed in the cash center.

The management device 10 obtains the transaction information from the banknote handling apparatus 100a (step S6). The management device 10 inputs the serial numbers of the banknotes 300 and the transaction information into the hash function prepared in advance to calculate a history hash value (step S7). That is, the history hash value is calculated based on the transaction information and the information indicating the serial numbers of the banknotes 300. The hash function and the history hash value respectively correspond to the handling-history function and the handling eigenvalue described with reference to FIG. 1 to FIG. 6.

As shown in FIG. 9, the management device 10 generates first block data 510 including the serial numbers of the banknotes 300 obtained from the banknote handling apparatus 100a, the transaction information, and the history hash value (step S8 shown in FIG. 8). In the example of FIG. 9, the serial numbers such as “X0001” and “X0004”, the transaction information including the store information “S01”, and the history hash value “0001” are included in the first block data 510.

As shown in FIG. 7, the banknotes handled by the banknote handling apparatus 100a in the store are transported to the cash handling center by the CIT company 450 (step S9 in FIG. 8). The store clerk only needs to pack the banknotes 300 handled by the banknote handling apparatus 100a into the bag 301, and pass the bag 310 to the CIT company 450.

The person in charge of banknote handling at the cash center handles the banknotes 300 collected from the store, by the banknote handling apparatus 100b in the cash center (step S10). The person in charge only needs to take out all the banknotes 300 from the bag 301, and handle these banknotes 300 by using the banknote handling apparatus 100b. In the banknote handling, the banknote handling apparatus 100b reads the serial number of each banknote. The banknote handling apparatus 100b may recognize a denomination of each banknote, count the number of banknotes for each denomination, calculate the amount of banknotes, and display the amount on the display unit.

The person in charge may input the transaction information into the banknote handling apparatus 100b (step S11). The person in charge can read a barcode attached to the bag 301, by using a barcode reader connected to the banknote handling apparatus 100b to input container information into the banknote handling apparatus 100b. The management device 10 can use the inputted container information as transaction information.

The person in charge may not necessarily input the transaction information. The banknote handling apparatus 100b in the cash center may use transaction information prepared in advance. For example, if the banknote handling apparatus 100b gives a transaction number to each banknote handling in order to specify the banknote handling, this transaction number may be used as the transaction information. For another example, apparatus information capable of specifying the banknote handling apparatus 100b may be used as the transaction information. If there is store information for specifying the cash center, the store information inputted to the banknote handling apparatus 100b in advance may be used as the transaction information. In the banknote handling, the banknote handling apparatus 100b transmits at least one of the transaction number, the apparatus information, and the store information to the management device 10 as the transaction information, whereby the management device 10 can use the received transaction information for generating block data.

If a serial number registered in the serial number list is detected when the banknotes 300 were handled in the store, the management device 100 notifies this serial number to the banknote handling apparatus 100b in the cash center (step S12).

The management device 10 obtains the serial numbers of the banknotes handled in the banknote handling apparatus 100b, and specifies the first block data 510 generated for the banknotes, based on the serial numbers, for example. If the person in charge has inputted the transaction information registered in the first block data 510, into the banknote handling apparatus 100 in step S11, the management device 10 may specify the first block data 510, based on the inputted transaction information. After specifying the first block data 510, the management device 100 notifies the banknote handling apparatus 100b of the serial number which is registered in the serial number list and has been detected and recorded when the first block data 510 was generated. The banknote handling apparatus 100b handles a banknote having the serial number notified from the management device 10, as a reject note.

For example, when the banknote handling apparatus 100b performs banknote handling in which banknotes received at an inlet are sorted and stacked into a reject unit and a stacking unit, the banknote handling apparatus 100b feeds the banknotes 300 from the inlet one by one into inside the apparatus, reads the serial number of each banknote, and rejects a banknote, whose serial number is included in the serial number list, in the reject unit while stacking other banknotes in the stacking unit. For another example, when the banknote handling apparatus 100b performs banknote handling in which the banknotes received at the inlet are sorted and discharged from the reject unit and an outlet, the banknote handling apparatus 100b rejects the banknote, whose serial number is included in the serial number list, from the reject unit while discharging other banknotes from the outlet.

When the banknote is rejected, a screen shown in FIG. 10A is displayed on the display unit of the banknote handling apparatus 100b. On the screen, information indicating the serial number registered in the serial number list, and information indicating that the banknote of this serial number has been rejected, are displayed. The person in charge who has confirmed the screen can handle the rejected note according to a predetermined procedure. For example, if the rejected note has the serial number of a counterfeit note or a stolen note, a report to a person in charge of dealing with a counterfeit note and a stolen note at the bank, submission of the banknote to the police, and the like are performed. If the banknote handling apparatus 100b has already handled the banknote having the notified serial number at the time of the notification in step S12, the banknote handling apparatus 100b may notify this to the person in charge, and the person in charge may specify the banknote to be rejected from among the already handled banknotes to deal with this banknote according to the predetermined procedure.

Processes in steps S14 to S18 are performed with the serial number registered in the serial number list being excluded. That is, second block data 520 is generated by using the serial numbers other than the serial number registered in the serial number list.

The management device 10 obtains the serial numbers of the banknotes 300 read by the banknote handling apparatus 100b (step S13). The management device 10 inputs the obtained serial numbers of the banknotes 300 into the hash function prepared in advance to calculate the serial-number hash value (step S14). That is, the serial-number hash value is calculated based on the information indicating the serial numbers of the banknotes 300.

The management device 10 determines whether or not the banknotes 300 handled by the banknote handling apparatus 100b of the cash center match the banknotes 300 handled by the banknote handling apparatus 100a of the store, and notifies the determination result according to need (step S15).

Specifically, the management device 10 compares the serial-number hash value calculated and stored in step S5 with the serial-number hash value calculated in step S14. When these hash values match, the management device 10 determines that the banknotes 300 handled in the banknote handling apparatus 100b of the cash center match the banknotes 300 handled in the banknote handling apparatus 100a of the store, and proceeds to the next step. At this time, the management device 10 may notify this matching of banknotes to the person in charge.

If the serial-number hash value calculated in step S14 does not match the serial-number hash value calculated in step S5, the management device 10 determines that the banknotes handled in the banknote handling apparatus 100b of the cash center do not match the banknotes 300 handled in the banknote handling apparatus 100a of the store. The management device 10 compares all the serial numbers obtained in step S13 with all the serial numbers registered in the first block data 510 to detect a mismatching serial number, and notifies the detected serial number to the person in charge. At this time, the detected serial number is displayed on the display unit of the banknote handling apparatus 100b, as shown in FIG. 10B. Specifically, if there is a serial number that is included in the first block data 510 but is not included in the serial numbers obtained in step S13, this serial number is displayed on the display unit. If there is a serial number that is not included in the first block data 510 but is included in the serial numbers obtained in step S13, this serial number is also displayed on the display unit. The person in charge can investigate the cause of such mismatching serial numbers, based on the information displayed on the display unit.

The determination as to whether or not the banknotes handled by the banknote handling apparatus 100b of the cash center match the banknotes 300 handled by the banknote handling apparatus 100a of the store, may be performed without using the serial-number hash value. For example, the management device 10 may compare the serial numbers read by the banknote handling apparatus 100b in the cash center with the serial numbers registered in the first block data 510.

The management device 10 obtains the transaction information from the banknote handling apparatus 100b (step S16). The management device 10 inputs the serial numbers of the banknotes 300, the transaction information, and the history hash value in the first block data 510 into the hash function prepared in advance to calculate a history hash value in the second block data 520 (step S17). That is, the history hash value in the second block data 520 is calculated based on the information indicating the serial numbers of the banknotes 300, the transaction information, and the information indicating the history hash value in the first block data 510.

As shown in FIG. 9, the management device 10 generates the second block data 520 including the serial numbers of the banknotes 300 and the transaction information obtained from the banknote handling apparatus 100b, and the history hash value (step S18). In the example shown in FIG. 9, the serial numbers such as “Y0001” and “X0005”, the transaction information including the store information “CS01” of the cash center, and the history hash value “0011” are included in the second block data 520.

As shown in FIG. 7, when the banknotes 300 are carried out from the store, these banknotes 300 are packed in the bag 301 at random. Therefore, if the serial numbers are registered in the order in which the banknotes were handled in the banknote handling apparatus 100b, there may be a mismatch between order of the serial numbers in the first block data 510 and order of the serial numbers in the second block data 520, as shown in FIG. 9. However, FIG. 9 is an example, and serial numbers arranged in ascending order or descending order may be registered in each block data.

In the cash center, an approver performs a process of approving the handling result that the person in charge has obtained by handling the banknotes 300 with the banknote handling apparatus 100b. In this process, the second block data 520 is approved by the approver. The approver operates the communication terminal 110 installed in the cash center to retrieve the block data from the management device 10 and display the retrieved block data on the display unit. The approver confirms the information included in the block data, and performs an approval operation by operating the operation unit of the communication terminal 110. The approval operation is performed by inputting predetermined information, which is to be used as transaction information, into the communication terminal 110 (step S19 shown in FIG. 8). The approver is a person other than the person in charge who handled the banknotes 300 by the banknote handling apparatus 100b. The approver may be an administrator who manages the person in charge or manages operations performed by the person in charge.

For example, the transaction information in the first block data 510 may include the total number and the total amount of the banknotes 300 counted by the banknote handling apparatus 100a in the store, and the transaction information in the second block data 520 may include the total number and the total amount of the banknotes 300 counted by the banknote handling apparatus 100b in the cash center. For example, the management device 10 may calculate the total number and the total amount of the banknotes 300 counted by the banknote handling apparatus 100a, based on the information in the first block data 510, and may calculate the total number and the total amount of the banknotes 300 counted by the banknote handling apparatus 100b, based on the information in the second block data 520. As described with respect to the identification information 13 shown in FIG. 1, by using a combination of the serial numbers (identification information) and denominations as the identification information 13 in each block data, the total amount can be calculated from the identification information 13. The approver retrieves the first block data 510 and the second block data 520 from the management device 10, displays them on the display unit of the communication terminal 110, and confirms that the total number and the total amount of the banknotes 300 handled in the store match the total number and the total amount of the banknotes 300 handled in the cash center.

The approver inputs, in the communication terminal 110, approver information capable of specifying each approver, and approves the second block data 520, i.e., the handling result in the banknote handling apparatus 100b. The approver information inputting method is not particularly limited. For example, the approver may manually input the approver information by operating the operation unit of the communication terminal 110. For example, the approver may input the approver information by causing a reading device such as a card reader or a barcode reader connected to the communication terminal 110 to read an IC card, a barcode, etc., including the approver information.

When the second block data 520 has been approved, the management device 10 obtains the transaction information inputted to the communication terminal 110 by the approver (step S20). The management device 10 inputs the serial numbers in the second block data 520, the transaction information obtained from the communication terminal 110, and the history hash value in the second block data 520 into the hash function prepared in advance to calculate a history hash value in third block data 530 (step S21). That is, the history hash value in the third block data 530 is calculated based on the information indicating the serial numbers of the banknotes 300, the transaction information, and the information indicating the history hash value in the second block data 520.

The management device 10 generates third block data 530 including the serial numbers in the second block data 520, the transaction information obtained from the communication terminal 110, and the history hash value (step S22). In the example shown in FIG. 9, the same serial numbers as those in the second block data 520, the transaction information including approver information “MGR01”, and the history hash value “0111” are included in the third block data 530. The transaction information may include the store information “CS01” of the cash center in addition to the approver information.

When banknotes are handled in the banknote handling apparatus 100a of the store, some of the banknotes may sometimes be rejected, although such rejection is omitted from examples of FIG. 7 to FIG. 10 to simplify the description. For example, the rejected notes include a note whose serial number cannot be read due to a stain, and a note whose denomination cannot be recognized.

When the banknote handling apparatus 100a has rejected a banknote, the clerk can manually input the amount of the rejected note by operating the operation unit of the banknote handling apparatus 100a. The management device 10 can store therein the amount of the rejected note manually inputted by the clerk and the amount of the banknotes 300 recognized and counted by the banknote handling apparatus 100a, and can manage the total of the manually inputted amount and the amount obtained by the apparatus 100a, as the proceeds from sales of the store.

The rejected note is handled separately from other normal banknotes 300 which have been handled without rejecting by the banknote handling apparatus 100a. The CIT company 450 puts the normal banknotes 300 handled by the banknote handling apparatus 100a into the bag 301 and transports these banknotes 300 as shown in FIG. 7. On the other hand, the CIT company 450 puts rejected notes in another bag or clips the rejected notes together and transports the rejected notes to the cash center.

In the cash center, as described above, the banknotes 300 in the bag 301 are handled by the banknote handling apparatus 100b. Aside from this handling, the person in charge or the approver deals with the rejected notes in the cash center. For example, a process of confirming whether or not the amount of the rejected notes transported from the store matches the amount of the rejected notes manually inputted at the store, is performed. For another example, a process of confirming whether or not the total of the amount of the rejected notes and the amount of the banknotes 300 recognized and counted by the banknote handling apparatus 100b, matches the total of the amount of the rejected notes manually inputted at the store and the amount of the banknotes 300 recognized and counted by the banknote handling apparatus 100a, is performed. If the amounts do not match in the above confirmation process, the cause of the mismatch will be investigated. If the amounts match, the total of the amount of the rejected notes and the amount of the banknotes 300 is approved as the proceeds from sales of the store, followed by post-processing for the proceeds from sales.

A banknote rejected by the banknote handling apparatus 100a is handled separately from other banknotes 300. Therefore, the serial number of the rejected note is not included in the serial numbers in the block data 510 to 530 shown in FIG. 9, but information on the rejected note may be included in the transaction information in the block data 510 to 530. For example, the management device 10 may add the amount of the rejected note manually inputted by the clerk, to the transaction information in the first block data 510. The management device 10 may add the amount of the rejected note confirmed by the person in charge at the cash center, to the transaction information in the second block data 520. The management device 10 may add the amount of the rejected note confirmed by the approver at the cash center, to the transaction information in the third block data 530.

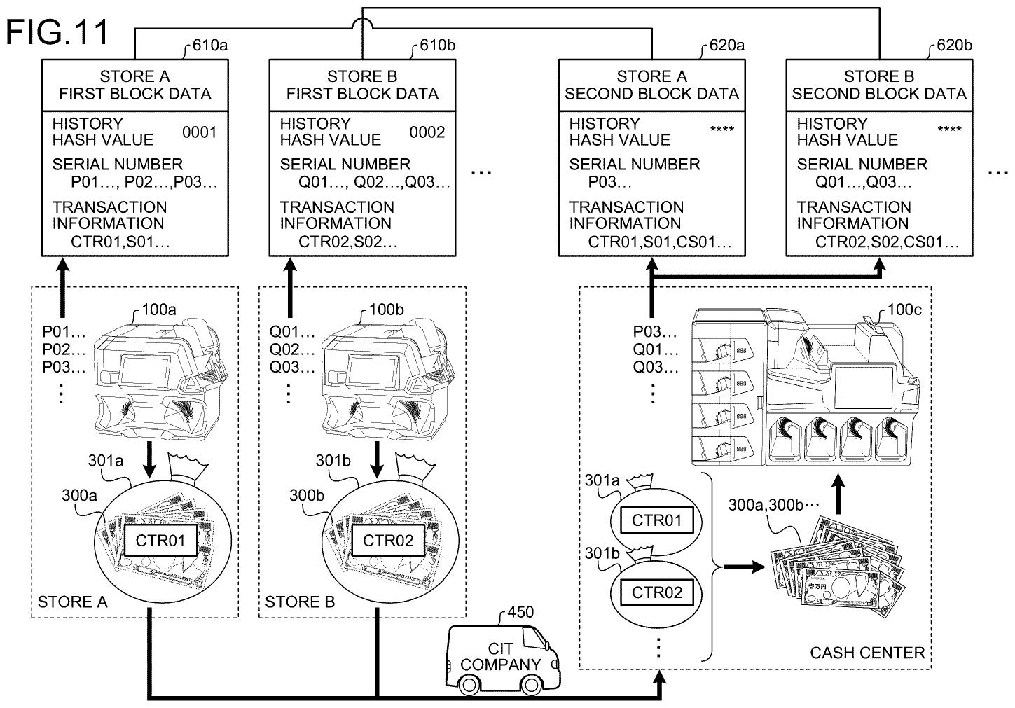

In FIG. 7 to FIG. 10, in order to simplify the description, the content of handling has been described with respect to one store as an example. However, the CIT company 450 may collect banknotes, which are proceeds from sales of each store, from a plurality of stores, and transport the collected banknotes to the cash center. FIG. 11 is a schematic diagram illustrating processing performed when banknotes are collected from a plurality of stores.

As shown in FIG. 11, when banknotes 300a are handled in a banknote handling apparatus 100a of a store A, first block data 610a of the store A is generated; and when banknotes 300b are handled in a banknote handling apparatus 100b of a store B, first block data 610b of the store B is generated. The CIT company 450 collects the banknotes 300a packed in a bag 301a from the store A, collects the banknotes 300b packed in a bag 301b from the store B, and transports the collected banknotes to the cash center.

The first block data 610a of the store A includes: the serial numbers of the banknotes 300a, such as “P01 . . . ”, “P02 . . . ”, and “P03 . . . ”; container information “CTR01” of the bag 301a; store information “S01” of the store A; and a history hash value “0001” calculated from them. For example, the container information attached to the bag 301a is read by a reading device such as a scanner or a barcode reader connected to the banknote handling apparatus 100a, whereby the container information is inputted to the banknote handling apparatus 100a and transmitted to the management device 10. For example, the store information is stored in the memory of the banknote handling apparatus 100a in advance, and is automatically transmitted to the management device 10 in the banknote handling.

The first block data 610b in the store B includes: the serial numbers of the banknotes 300b, such as “Q01 . . . ”, “Q02 . . . ”, and “Q03 . . . ”; container information “CTR02” of the bag 301b; store information “S02” of the store B; and a history hash value “0002” calculated from them. Similarly to the store A, the container information of the bag 301b read by the reading device is transmitted from the banknote handling apparatus 100b to the management device 10, and the store information of the store B stored in the memory in advance is automatically transmitted to the management device 10.

In the cash center, the banknotes collected from the plurality of stores are handled together. The banknotes 300a of the store A taken out from the bag 301a and the banknotes 300b of the store B taken out from the bag 301b are handled in a mixed state by the banknote handling apparatus 100c. The person in charge at the cash center need not distinguish the banknotes 300a of the store A from the banknotes 300b of the store B, and therefore, can easily handle the banknotes. When banknote handling has started, the management device 10 obtains the serial numbers read by the banknote handling apparatus 100c, and searches for the first block data.

For example, the management device 10, which finds the first block data 610a of the store A from the serial number “P03 . . . ” firstly obtained by the banknote handling apparatus 100c, generates second block data 620a of the store A. Likewise, for example, the management device 10, which finds the first block data 610b of the store B from the serial number “Q01 . . . ” secondly obtained by the banknote handling apparatus 100c, generates second block data 620b of the store B.

The transaction information may be used for searching for the first block data. The container information “CTR01” of the bag 301a is registered as the transaction information in the first block data 610a of the store A, and the container information “CTR02” of the bag 301b is registered as the transaction information in the first block data 610b of the store B. In the cash center, the person in charge reads the container information attached to the bags 301a, 301b by using the reading device such as a scanner or a barcode reader connected to the banknote handling apparatus 100c, whereby the container information is transmitted from the banknote handling apparatus 100c to the management device 10. The management device 10 recognizes the first block data 610a of the store A from the container information “CTR01”, and recognizes the first block data 610b of the store B from the container information “CTR02”.

The management device 10, which has recognized the first block data 610a, 610b of the store A and the store B, confirms whether each serial number obtained in the banknote handling apparatus 100c of the cash center is registered in the first block data 610a of the store A or the first block data 610b of the store B. If the serial number obtained in the banknote handling apparatus 100c matches any of the serial numbers in the first block data 610a of the store A, the management device 10 registers this serial number in the second block data 620a of the store A. If the serial number matches any of the serial numbers in the first block data 610b of the store B, the management device 10 registers this serial number in the second block data 620b of the store B.

As described above, when the banknotes 300a, 300b of the plurality of stores are handled together in the banknote handling apparatus 100c, the second block data 620a, 620b are generated while each of the serial numbers obtained in the banknote handling apparatus 100c is compared with the serial numbers in the first block data 610a, 610b. Therefore, the management device 10 can determine whether or not the banknotes 300a and the banknotes 300b handled in the banknote handling apparatus 100c match the banknotes 300a handled in the banknote handling apparatus 100a of the store A and the banknotes 300b handled in the banknote handling apparatus 100b of the store B, respectively, without using a serial-number hash value.

Since FIG. 11 shows the state in the middle of the processing, history hash values in the second block data 620a, 620b have not yet been calculated. When banknote handling by the banknote handling apparatus 100c has ended, the management device 10 calculates the history hash value in the second block data 620a of the store A, based on the history hash value in the first block data 610a of the store A and on the serial numbers and the transaction information in the second block data 620a. The management device 10 registers the calculated history hash value in the second block data 620a. Likewise, the management device 10 calculates a history hash value in the second block data 620b of the store B, based on the history hash value in the first block data 610b of the store B and on the serial numbers and the transaction information in the second block data 620b. The management device 10 registers the calculated history hash value in the second block data 620b. For example, the store information of the cash center is stored in the memory of the banknote handling apparatus 100c in advance. The store information is automatically transmitted to the management device 10 and used as the transaction information when the banknote handling is performed in the cash center.

The second block data 620a of the store A is managed in association with the first block data 610a of the store A, and the second block data 620b of the store B is managed in association with the first block data 610b of the store B. The block data 610a, 620a of the store A are managed separately from the block data 610b, 620b of the store B.

In the example shown in FIG. 11, the second block data 620a of the store A includes the serial numbers of the banknotes 300a, the container information “CTR01” of the bag 301a, the store information “S01” of the store A, the store information “CS01” of the cash center, and the history hash value. The second block data 620b of the store B includes the serial numbers of the banknotes 300b, the container information “CTR02” of the bag 301b, the store information “S02” of the store B, the store information “CS01” of the cash center, and the history hash value.

Although the case of using the transaction information is illustrated in FIG. 11, the transaction information may not necessarily be used. When the transaction information is not used, the clerk of each store only needs to handle the banknotes by the banknote handling apparatus 100a, 100b, pack the banknotes in the bag 301a, 301b, and pass the bag to the CIT company 450. The person at the cash center who is in charge of banknote handling only needs to handle the banknotes carried into the cash center, by the banknote handling apparatus 100c. Each of the banknote handling apparatuses 100a to 100c reading the serial numbers of the banknotes allows the management device 10 to generate the first block data and the second block data of the corresponding store.

Even in the case of using the transaction information, the transaction information such as the aforementioned container information can be easily inputted by using the reading device connected to each of the banknote handling apparatuses 100a to 100c. When the transaction information such as the store information stored in the memory of each of the banknote handling apparatuses 100a to 100c in advance is used, an input operation for the transaction information needs not be performed. This reduces the load, regarding banknote handling, on the clerk at the store and the person in charge at the cash center.

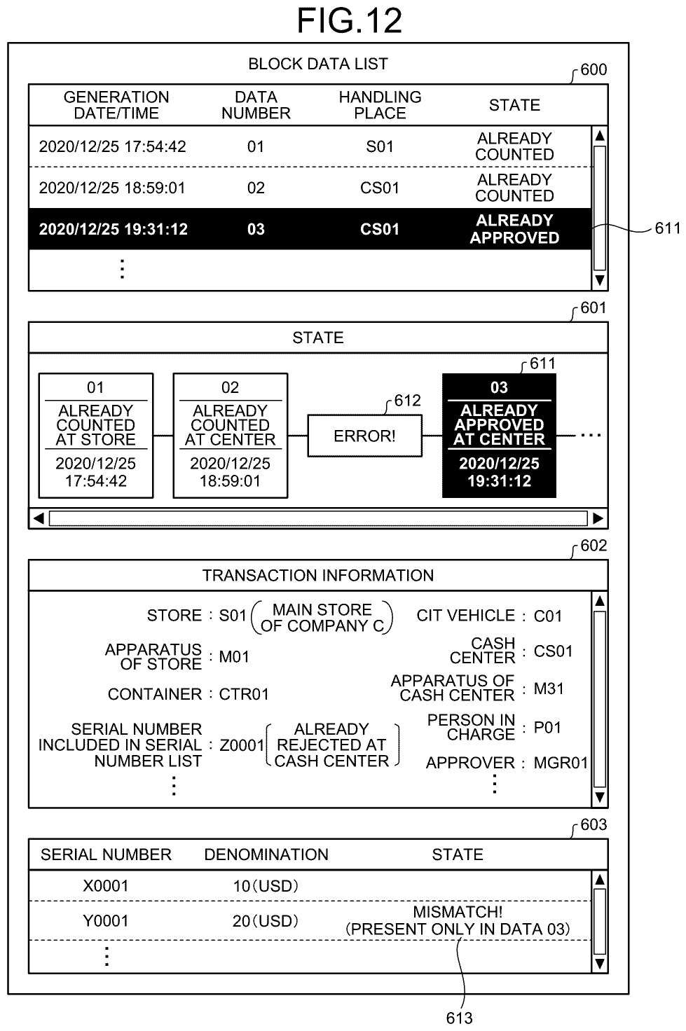

The person in charge and the approver at the cash center can confirm the block data managed in the management device 10, by using the banknote handling apparatus 100 of the cash center, or the communication terminal 110. FIG. 12 shows an example of a screen displaying the block data.

For example, when the approver confirms the block data by operating the operation unit of the communication terminal 110, the screen shown in FIG. 12 is displayed on the display unit of the communication terminal 110. As shown in FIG. 12, a list of block data that the management device 10 manages in association with each other is displayed in a frame 600 in an upper part of the screen. For example, date and time when each block data was generated, a data number of the block data, a place where banknotes were handled when the block data was generated, and the state of the block data, are displayed in the frame 600. The block data having the data numbers “01” to “03” shown in FIG. 12 correspond to the first to third block data, respectively. Since each block data shown in FIG. 12 has already been generated, “already counted” or “already approved” is displayed under the item “state”. However, for example, if the second block data is being generated, “processing” is displayed under the item “state” for the data number “02”.

Each block data is graphically displayed in a frame 601. In the example shown in FIG. 12, each of the block data listed in the frame 600 is displayed as a rectangle, and relationship between adjacent block data is displayed as a straight line connecting the rectangles. If the approver selects block data in the frame 600 or the frame 601 by operating the operation unit of the communication terminal 110, the selected block data is displayed distinguishably from the other block data. FIG. 12 shows an example where third block data 611 having the data number “03” is selected.

Transaction information of the selected block data is displayed in a frame 602. The transaction information shown in FIG. 12 allows confirmation of various information with respect to banknotes whose information is registered in the selected third block data 611. For example, in the example shown in FIG. 12, it can be confirmed that the banknotes were collected from a main store of company C having store information “S01”, and were handled by a banknote handling apparatus 100 having apparatus information “M01” and installed in this store. In addition, it can be confirmed that a banknote having a serial number “Z0001” registered in the serial number list was detected during banknote handling in the store, and this banknote was treated as a rejected note in the cash center. Furthermore, it can be confirmed that the banknotes were stored in a container having container information “CTR01”, and were transported to the cash center having store information “CS01” by a CIT vehicle having vehicle information “C01”. Moreover, it can be confirmed that, in the cash center, the banknotes were handled by a person in charge having person-in-charge information “P01” by using a banknote handling apparatus 100 having apparatus information “M31”, and a banknote handling result, i.e., the second block data, was approved by an approver having approver information “MGR01”.

In a frame 603, banknote information in the selected block data is displayed. In the example shown in FIG. 12, banknote information in the third block data 611 is displayed. From the banknote information, it can be confirmed that the third block data 611 includes a US 10-dollar note having a serial number “X0001”, a US 20-dollar note having a serial number of “Y0001”, etc. For example, the management device 10 registers, in the block data, identification information including the denomination and the serial number of each banknote, such that identification information of the US 10-dollar note having the serial number “X0001” becomes “USD-X0001”. As a result, information on each banknote can be displayed as shown in FIG. 12.

When displaying the screen shown in FIG. 12, the management device 10 recalculates the history hash value in each block data to confirm whether the data is normal. For example, if the banknote information included in the second block data has been falsified, the management device 10 can detect this falsification as described with reference to FIG. 6. The management device 10, which has detected a mismatch between the second block data and the third block data, notifies abnormality in data on the screen of the communication terminal 110. For example, as shown in the frame 601 of FIG. 12, the management device 10 displays an error mark 612 between the block data, for which inconsistency was found, to notify abnormality in data.

When the inconsistency was found between block data, the management device 10 compares the serial numbers between the block data to detect a mismatching serial number, as described with reference to FIG. 6. For example, if there is a serial number that is registered in the third block data but is not registered in the second block data, the management device 10 displays warning information 613 indicating abnormality to notify the abnormality, as shown in the frame 603 of FIG. 12. The example shown in FIG. 12 indicates that the serial number “Y0001” registered in the third block data is not registered in the second block data. Since inconsistency of data occurs between the second block data and the third block data, the approver can perform investigation, taking into account the possibility that falsification on the banknote having the serial number “Y0001”, e.g., deletion of the serial number, was performed. If the cause of the inconsistency between the second block data and the third block data is the transaction information, warning information indicating abnormality is displayed in the frame 602 for displaying the transaction information.

As described above, in the sheet management system 1, it is possible to easily confirm the block data managed by the management device 10, and the transaction information and the banknote information registered in each block data. If there is abnormality in data due to falsification or the like on the block data, the management device 10 detects and notifies this fact. Upon receiving the notification, the user can confirm the block data and take an appropriate action.

In the present embodiment, the reading device such as a barcode reader, a card reader, or a scanner is mainly used for inputting information such as transaction information performed in the sheet management system 1. However, the information inputting method is not particularly limited. The information may be inputted through a manual operation by using an input device such as a keyboard, or may be inputted with voice using a voice inputting technology.

In the present embodiment, the notification process in the sheet management system 1 is performed by displaying the content of notification mainly on the display units of the related devices 10, 100, 110. However, the notification method is not particularly limited. The notification process may be performed by emitting sound and/or light. For example, the notification process may be performed by emitting sound and/or light from a predetermined communication terminal using a wireless communication technology. Alternatively, the notification process may be performed by transmitting predetermined information to a notification destination registered in advance. For example, the notification process may be performed by transmitting a predetermined notification to addresses registered in advance, using application software for transmitting an email, a message, etc.

A sheet management device according to the present disclosure is configured to: generate first block data that includes identification information of a plurality of sheets handled by a first sheet handling apparatus and a first eigenvalue calculated based on first input values including the identification information; generate second block data that includes identification information obtained by handling the plurality of sheets by a second sheet handling apparatus and a second eigenvalue calculated based on second input values including information on the first eigenvalue and the identification information obtained by the second sheet handling apparatus; and manage the second block data in association with the first block data.

In the above configuration, in a case where the sheet management apparatus receives transaction information related to sheet handling, the input values may include the transaction information, and the sheet management device may calculate the eigenvalue from the input values including the transaction information and add the transaction information to the block data.

In the above configuration, the eigenvalue may be a fixed-length value that is calculated by inputting the input values into a predetermined function and changed according to the input values.

In the above configuration, in a case where the plurality of sheets are handled a plurality of times, in first handling, the sheet management device may generate the first block data including: identification information of the sheets obtained in the first handling; and the first eigenvalue calculated based on the first input values including the identification information. In second and subsequent handlings, the sheet management device may generate n-th (n: integer not less than 2) block data including: identification information of the sheets obtained in n-th handling; and an n-th eigenvalue calculated based on n-th input values including information on an (n−1)-th eigenvalue and the identification information obtained in the n-th handling. The sheet management device may manage all the generated block data in association with each other by associating the n-th block data with the (n−1)-th block data.

In the above configuration, if the n-th eigenvalue included in the n-th block data does not match an eigenvalue that is recalculated based on the n-th input values, the sheet management device may determine that there is abnormality in consistency between the n-th block data and the (n−1)-th block data, and perform a notification process for notifying determination result to a person in charge.

In the above configuration, in a case where an eigenvalue included in block data does not match a value obtained by recalculating the eigenvalue, the sheet management device may determine that there is abnormality in the block data, and perform a notification process for notifying determination result to a person in charge.

In the above configuration, in a case where an eigenvalue calculated based on the identification information obtained by the first sheet handling apparatus does not match an eigenvalue calculated based on the identification information obtained by the second sheet handling apparatus, the sheet management device may determine that the sheets handled in the second sheet handling apparatus do not match the sheets handled in the first sheet handling apparatus, and perform a notification process for notifying determination result to a person in charge.

In the above configuration, in a case where information on a sheet corresponding to identification information obtained by the first sheet handling apparatus is included in a list in which pieces of identification information to be detected are registered in advance, the sheet management device may perform a notification process for notifying this to a person in charge.

A sheet management system according to the present disclosure includes: a first sheet handling apparatus configured to receive a plurality of sheets and obtain identification information from each sheet; a second sheet handling apparatus configured to receive the plurality of sheets and obtain the identification information from each sheet; and a management device configured to generate first block data that includes the identification information obtained by the first sheet handling apparatus and a first eigenvalue calculated based on first input values including the identification information, generate second block data that includes the identification information obtained by the second sheet handling apparatus and a second eigenvalue calculated based on second input values including information on the first eigenvalue and the identification information obtained by the second sheet handling apparatus, and manage the second block data in association with the first block data.

A sheet management method according to the present disclosure is a method that allows a management device to manage a plurality of sheets when the sheets are handled a plurality of times. The method includes: generating, in first handling, first block data that includes identification information of the sheets obtained in the first handling and a first eigenvalue calculated based on first input values including the identification information; generating, in n-th (n: integer not less than 2) handling, n-th block data that includes identification information of the sheets obtained in the n-th handling and an n-th eigenvalue calculated based on n-th input values including information on an (n−1)-th eigenvalue and the identification information obtained in the n-th handling, and associating the n-th block data with the (n−1)-th block data.

As described above, in the sheet management system according to the present embodiment, a group of sheets can be easily managed. When the sheets are handled a plurality of times, the sheet management device can generate block data at each handling, and manage the generated block data in association with each other. Since the block data includes identification information capable of specifying each sheet having been handled, it is possible to specify, based on the block data, all the sheets handled in each handling. Since transaction information related to sheet handling can be included in the block data, the user may add necessary information to the transaction information and confirm the transaction information in the block data according to need. The block data includes a handling eigenvalue obtained by inputting the input values including sheet identification information and transaction information into a predetermined function. In the second and subsequent handling, a handling eigenvalue is generated from the input values including the handling eigenvalue in the immediately previous handling. Therefore, if even one piece of information included in the block data is falsified, this falsification can be detected based on a change in the handling eigenvalue, and on consistency with other block data.

As described above, the sheet management device, the sheet management system, and the sheet management method according to the present disclosure are useful in managing a group of sheets to be distinguished from other sheets.

1. A sheet management device configured to:
generate first block data that includes identification information of a plurality of sheets handled by a first sheet handling apparatus and a first eigenvalue calculated based on first input values including the identification information;
generate second block data that includes identification information obtained by handling the plurality of sheets by a second sheet handling apparatus and a second eigenvalue calculated based on second input values including information on the first eigenvalue and the identification information obtained by the second sheet handling apparatus; and
manage the second block data in association with the first block data.

2. The sheet management device according to claim 1, wherein
in a case where the sheet management device receives transaction information related to sheet handling, the input values includes the transaction information, and the sheet management device calculates the eigenvalue from the input values including the transaction information and adds the transaction information to the block data.

3. The sheet management device according to claim 1, wherein
the eigenvalue is a fixed-length value that is calculated by inputting the input values into a predetermined function and changed according to the input values.

4. The sheet management device according to claim 1, wherein
in a case where the plurality of sheets are handled a plurality of times,
in first handling, the sheet management device generates the first block data including: identification information of the sheets obtained in the first handling; and the first eigenvalue calculated based on the first input values including the identification information,
in second and subsequent handlings, the sheet management device generates n-th (n: integer not less than 2) block data including: identification information of the sheets obtained in n-th handling; and an n-th eigenvalue calculated based on n-th input values including information on an (n−1)-th eigenvalue and the identification information obtained in the n-th handling, and
the sheet management device manages all the generated block data in association with each other by associating the n-th block data with the (n−1)-th block data.

5. The sheet management device according to claim 4, wherein
in a case where the n-th eigenvalue included in the n-th block data does not match an eigenvalue that is recalculated based on the n-th input values, the sheet management device determines that there is abnormality in consistency between the n-th block data and the (n−1)-th block data, and performs a notification process for notifying determination result to a person in charge.

6. The sheet management device according to claim 1, wherein
in a case where an eigenvalue included in block data does not match a value obtained by recalculating the eigenvalue, the sheet management device determines that there is abnormality in the block data, and performs a notification process for notifying determination result to a person in charge.

7. The sheet management device according to claim 1, wherein
in a case where an eigenvalue calculated based on the identification information obtained by the first sheet handling apparatus does not match an eigenvalue calculated based on the identification information obtained by the second sheet handling apparatus, the sheet management device determines that the sheets handled in the second sheet handling apparatus do not match the sheets handled in the first sheet handling apparatus, and performs a notification process for notifying determination result to a person in charge.

8. The sheet management device according to claim 1, wherein
in a case where information on a sheet corresponding to identification information obtained by the first sheet handling apparatus is included in a list in which pieces of identification information to be detected are registered in advance, the sheet management device performs a notification process for notifying it to a predetermined person.

9. A sheet management system comprising:
a first sheet handling apparatus configured to receive a plurality of sheets and obtain identification information from each sheet;
a second sheet handling apparatus configured to receive the plurality of sheets and obtain the identification information from each sheet; and
a management device configured to
generate first block data that includes the identification information obtained by the first sheet handling apparatus and a first eigenvalue calculated based on first input values including the identification information obtained by the first sheet handling apparatus,
generate second block data that includes the identification information obtained by the second sheet handling apparatus and a second eigenvalue calculated based on second input values including information on the first eigenvalue and the identification information obtained by the second sheet handling apparatus, and
manage the second block data in association with the first block data.

10. A sheet management method that allows a management device to manage a plurality of sheets when the sheets are handled a plurality of times, the method comprising:
generating, in first handling, first block data that includes identification information of the sheets obtained in the first handling and a first eigenvalue calculated based on first input values including the identification information;
generating, in n-th (n: integer not less than 2) handling, n-th block data that includes identification information of the sheets obtained in the n-th handling and an n-th eigenvalue calculated based on n-th input values including information on an (n−1)-th eigenvalue and the identification information obtained in the n-th handling, and
associating the n-th block data with the (n−1)-th block data.
